(19) United States
(12) Patent Application Publication
(10) Pub. No.: US 2012/0024242 A1
(43) Pub. Date: Feb. 2, 2012

(54) Protecting Passengers and Internal Combustion Engines from a Malfunctioning Hydrogen/Oxygen Generator Apparatus

(76) Inventor: Maurizio Mario Gramigni, Boca Raton, FL (US)

(21) Appl. No.: 13/014,739

(22) Filed: Jan. 27, 2011

Related U.S. Application Data
(60) Provisional application No. 61/330,336, filed on May 1, 2010.

(51) Int. Cl. F02B 43/10; C25B 1/02

(52) U.S. Cl. 123/3; 205/628

(57) ABSTRACT

A series of control circuits and the use of a stable Hydrogen/Oxygen Generator Cell to protect passengers and automobile from fire or destruction of the engine under malfunction conditions.

Improper electrolyte concentration, cell running at very low or very high electrolyte level, or water reaching the motor intake, may cause serious hazard conditions or damage to the vehicle and the occupants.

### BACKGROUND OF THE INVENTION

This patent relates to a system for securing an installation of an Hydrogen/Oxygen Generator Apparatus on a traditional Internal Combustion Engine Vehicle using Gasoline, Diesel or Propane fuels. With the proliferation of many incomplete and short-term testing systems and different cells available for installation in vehicles, the risk of a system malfunction increases. Due to the increased number of different makes of vehicles, to make a secure Hydrogen/Oxygen Generator Apparatus installation becomes more personalized and complex in respect to the safety of the occupants and the secure operation of the Internal Combustion Engine.

Today there many types of cells available (wet cell, dry cell, etc.), but all are sold without the electrolyte. They suggest using electrolytes without specifying the proper and safe chemical composition. Each cell, based on the manufacturing specifications, works with a specific electrolyte composition to ensure stability and efficiency. Using the wrong electrolyte composition may cause serious damage to the cell and the system where the cell is used, and also to the vehicle and its occupants. This is the primary reason to implement a secure system in traditional internal combustion engines.

This System:

1. allows the production of Hydrogen/Oxygen only when the motor is running

2. controls the level of the electrolyte into the cells

3. assures that the reservoir is NOT empty and the cells are running with the proper level of electrolyte.

One of the most important features of the system is the use of a Bubbler (as described forward) with multiple functions. The most important characteristic is to assure that under any circumstances water is not transferred to the engine's intake, putting the functionality of the internal combustion engine at serious risk. Before this can happen a Bubbler Water Level Sensor will shut down the complete system.

Insofar as I am aware, no system or method for securing and controlling an Hydrogen/Oxygen Generator Apparatus in vehicle has ever been implemented. One example, but not detailed and complete apparatus can be found in U.S. Pat. No. 6,257,175 from Edward G. Mosher and John T. Webster (1999).

### SUMMARY OF THE INVENTION

In response to the issue of SAFTEY I have developed the first System to protect the occupants of the vehicle and the internal combustion engine. The applications and advantages of this System can be understood from a study of the following description and accompanying drawings.

### BRIEF DESCRIPTION OF THE DRAWING

FIG. 1 The Cell

FIG. 2 Electric Circuit

FIG. 3 Electrolyte and Hydrogen/Oxygen Circuit

### DETAILED DESCRIPTION OF THE DRAWING

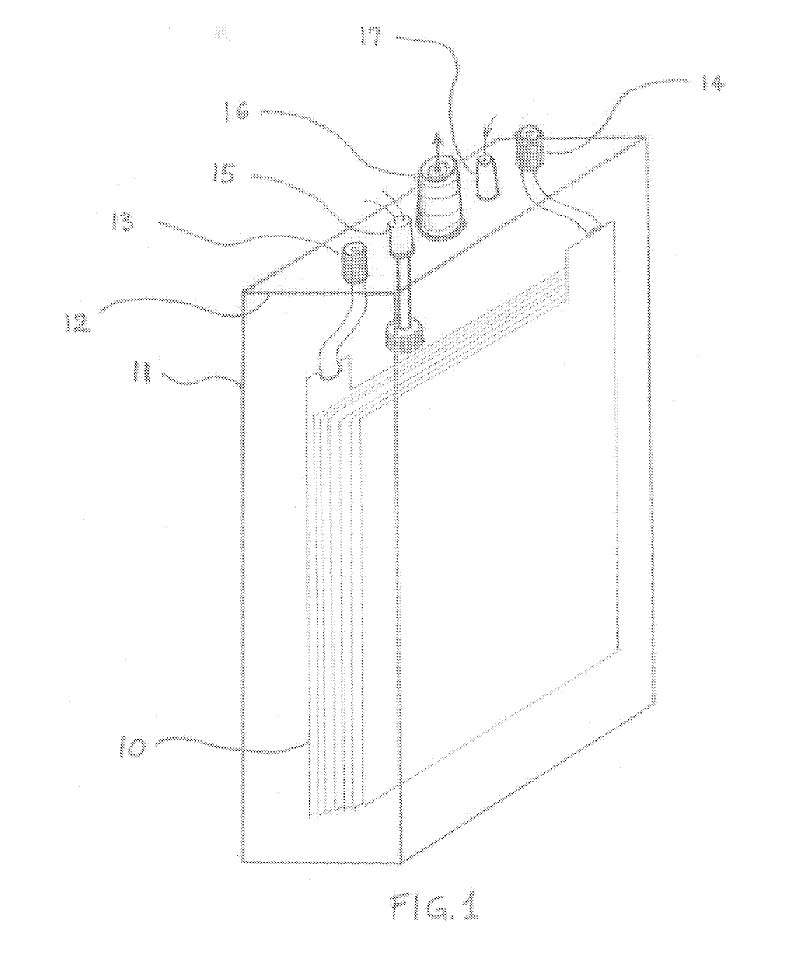

FIG. 1 The Cell

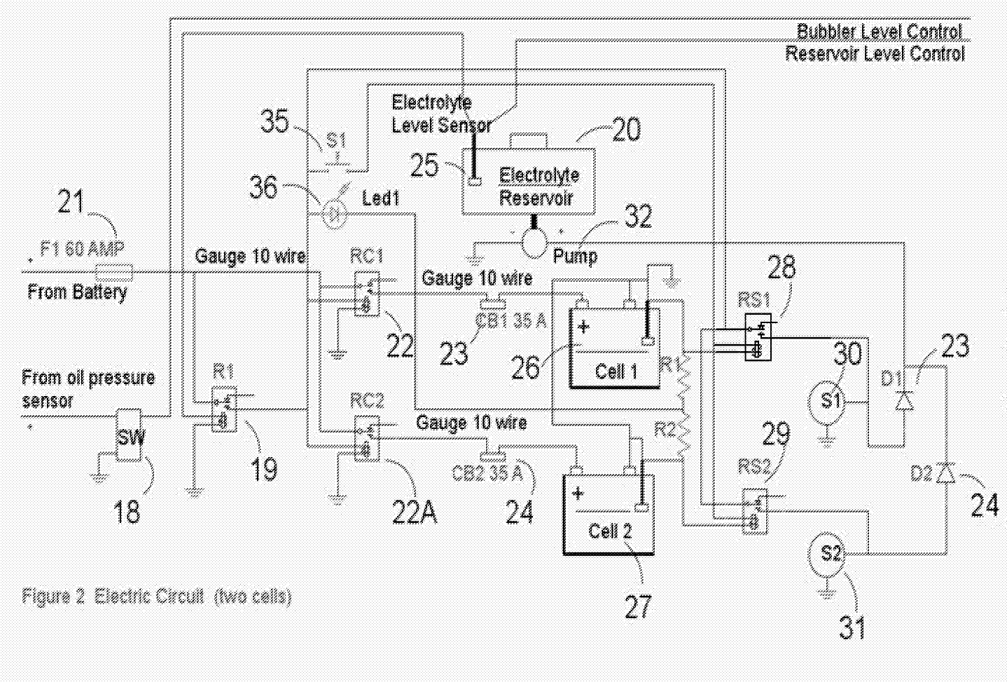

Seven elements 10 of 316L stainless steel are in a small and solid container 11 of Plexiglas. On the top cover 12 there are the Negative connector 13, the Positive connector 14, the Electrolyte Level Sensor 15, the Hydrogen/Oxygen output (gas) 16 and the Electrolyte input (liquid) 17. The electrolyte level is controlled by the Electrolyte Level Sensor 15 and the electric circuit of FIG. 2. Th electrolyte is a composition of Potassium hydroxide (KOH) and distilled water.

The electrolyte composition and all the dimension of the plates inside the cell are critical for the operational stability and efficiency of the cell.

FIG. 2 Electric Circuit

If a +12V is present at the input of the Oil Pressure Switch 18, the +12V is transferred to the coil of the relay R1 19 if the Reservoir 20 and the Bubbler 39 are not full of electrolyte (Reservoir) or of water (Bubbler). Through the Fuse 21 the +12V, directly from the main battery, is distributed to the Cell 1 26 and the Cell 2 27 via the relay RC1 22 and the relay RC2 22A.

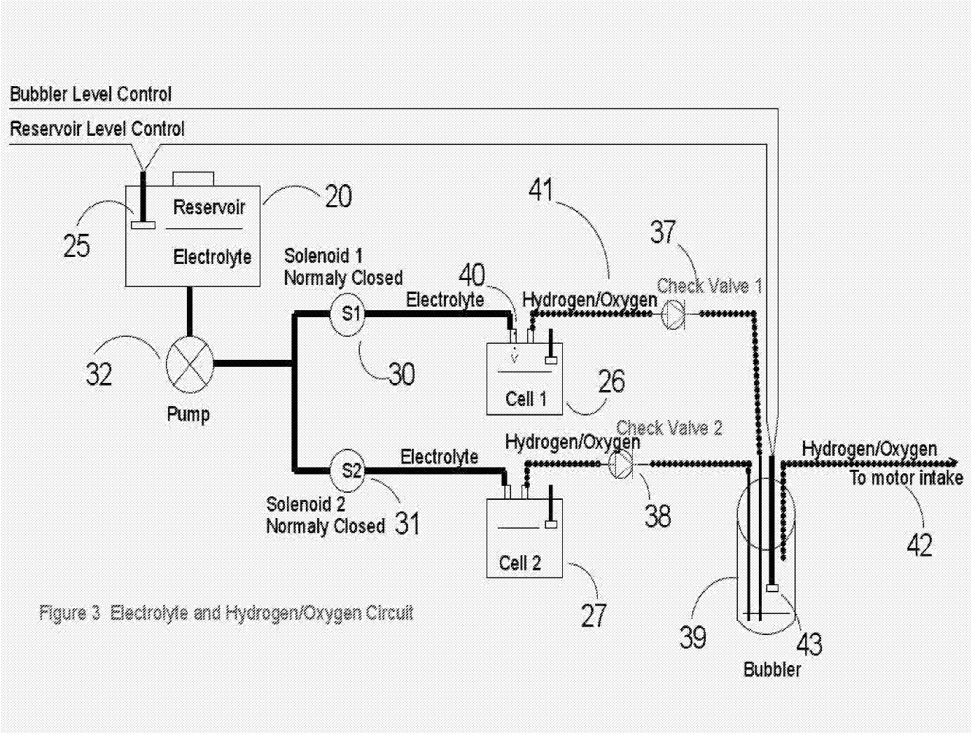

Additional safety units are added: the Circuit Breaker 1 23 and the Circuit Breaker 2 24. They are opening the circuit if the current reach the preset value. The electrolyte level is controlled in the Cell 1 26 and Cell 2 27 by the relay RS1 28 and RS2 29 and the Normally Closed Solenoid S1 30 and S2 31. The relay RS1 28 and RS2 29 activate the Pump 32 and open the Solenoid 30 or 31 independently controlled by the Diodes 23 and 24. The flow of the electrolyte and the Hydrogen/Oxygen gas will be described and illustrated in FIG. 3. When the Led1 36 is activated, holding down the switch S1 35 for few seconds allows the automatic refiling system to maintain the right level of electrolyte in the two cells.

FIG. 3 Electrolyte and Hydrogen/Oxygen Circuit

Once the Pump 32 is activated by the relay RS1 28 or RS2 29 (in FIG. 2), the Solenoid S1 30 and/or S2 31 will open and the electrolyte is going in Cell 1 and/or Cell 2 (in FIG. 3 the Cell 1 is in the refilling status 40). Cell 1 26 and Cell 2 27 continuously produce Hydrogen/Oxygen gas 41 going in the Bubbler 39 via two Check Valve 1 37 and Check Valve 2 38. These two Check Valve 37 and 38 allow the Hydrogen/Oxygen to go only in one direction, from the cell to the bubbler and not vice-versa. The Bubbler 39 has a dual functionality: to purify the Hydrogen/Oxygen gas and as safety feature, to protect the internal combustion engine in case of backfiring 42. An additional feature is the Safety Level Sensor 43. This sensor will shot off the whole system if the water level reach the level of the sensor 43.

REFERENCE NUMBER FIG. 1
10 Stained Steel Plates
11 Cell Container
12 Top Cover
13 Negative Connector
14 Positive Connector
15 Electrolyte Level Sensor
16 Hydrogen/Oxygen Output
17 Electrolyte Input

REFERENCE NUMBER FIG. 2
18 Oil Pressure Switch
19 Relay R1
20 Reservoir
21 Fuse
22 Relay RC1
22A Relay RC2
23 Circuit Breaker 1
24 Circuit Breaker 2
25 Reservoir Level Sensor
26 Cell 1
27 Cell 2
28 Relay RS1
29 Relay RS2
30 Solenoid S1
31 Solenoid S2
32 Pump
33 Diode D1
34 Diode D2
35 Switch S1
36 Level Indicator LED1

REFERENCE NUMBER FIG. 3
37 Check Valve 1
38 Check Valve 2
39 Bubbler
40 Electrolyte in Cell 1
41 Hydrogen/Oxygen gas
42 Motor Intake
43 Bubbler Security Level Sensor

1. A method to produce a stable cell as described in the specifications, generating 1.5 LPM (Liter Per Minute) of Hydrogen/Oxygen.
We accomplish this under two conditions:
a. Using an electrolyte composed of a specific mixture of distilled water and Potassium hydroxide (KOH).
b. Producing a cell following the specifications.

2. The electrolyte Level Sensor in the cell with the relative circuits, maintains a constant electrolyte level to cover all stainless steel plates. This is one of the conditions to maintain a stable production of Hydrogen/Oxygen. In fact if the electrolyte level decrease, the cell internal temperature increase, reaching, in some cases, the complete destruction of the cell. If the electrolyte level increases, the cell begins producing water vapor in addition to Hydrogen/Oxygen. This water vapor going into the Bubbler may start reaching the intake of the engine with disastrous consequences, resulting in the destruction of the internal combustion engine.

3. The method according to claim 2, wherein electrolyte Reservoir Level Sensor assures that the Electrolyte Reservoir is not empty. If this condition occurs the whole system will be shut down immediately.

4. To avoid backfire from the internal combustion engine (caused by accumulation of Hydrogen/Oxygen in the intake manifold when the engine is not running), the production of Hydrogen/Oxygen can begin ONLY if the engine is running. This is accomplished using the signal from the engine oil pressure switch to control the entire system.

5. The method according to claim 2, wherein the water level in the Bubbler is controlled to protect the life of the internal combustion engine. If for some reason water accumulates in the Bubbler reaching the Liquid Level Sensor Control, the whole system will be shut down immediately.
